(19) United States
(12) Patent Application Publication
(10) Pub. No.: US 2025/0202102 A1
(43) Pub. Date: Jun. 19, 2025

(54) ANTENNA SYSTEM FOR INDUSTRIAL ENVIRONMENT

(71) Applicant: Telefonaktiebolaget LM Ericsson (publ), Stockholm (SE)

(72) Inventors: Hideshi MURAI, Kanagawa (JP); Junaid ANSARI, Aachen (DE); Jan DIEKMANN, Düsseldorf (DE); Leefke GROSJEAN, Täby (SE)

(21) Appl. No.: 18/838,071

(22) PCT Filed: Feb. 14, 2022
(86) PCT No.: PCT/SE2022/050162

§ 371 Date: Aug. 13, 2024

(51) Int. Cl. H01Q 3/00; H01Q 1/12; H01Q 1/28; H04B 7/06

(52) U.S. Cl. CPC H01Q 3/005; H01Q 1/1242; H01Q 1/28; H04B 7/063

(57) ABSTRACT

Embodiments of the present disclosure provide an antenna system for operating in an industrial environment including a plurality of industrial devices. Each industrial device being connected to a user equipment (UE). The antenna system including an antenna and a support for supporting the antenna in an elevated position in relation to ground and facing towards the ground. The antenna being adapted for generating beams towards the ground for communicating with the UE.

### TECHNICAL FIELD

The present disclosure relates generally to the field of industrial environment. More particularly, it relates to methods, antenna system, apparatus, and computer program products for serving one or more industrial devices in an industrial environment.

### BACKGROUND

Industrial automation is becoming increasingly popular due to rapid development in sensors, control system, and other manufacturing techniques. In industrial automation, various kinds of industrial devices (such as 6DOF robotic arms, collaborating robotic arms, Automated Guided Vehicles, AGVs, with Omni-wheels, excavators, or other robotic devices) are used to automate various processes in industries. For example, an industrial environment includes a plurality of industrial devices that receive control messages from an industrial controller and perform assigned one or more operations.

In the industrial environment, the plurality of industrial devices can be equipped with a plurality of user equipments, UEs.

FIG. 1 discloses an example antenna deployment. As seen in FIG. 1, antenna 102a is serving an industrial environment 102 and an antenna 104a is serving an industrial environment 104. The antenna 102a communicates with UEs in the industrial environment 102, whereas the antenna 104a communicates with UEs in the industrial environment 104 using antenna beams. The antenna beams as seen in the FIG. 1 are in vertical as well as in horizontal direction. The antenna beams of the antennas 102a and 104a in the horizontal direction interfere with each other causing outside area interference.

The wireless communication services (e.g. 5G and 6G) suffer from the outside area interference and hence need to coordinate with a licensee in the surrounding area to avoid the outside area interference. The coordination with the licensee in the surrounding area consumes a lot of time, and in some cases also limits the performance of the antenna, such as overconsumption of a transmitter power, Tx power, irregularity in a Time Domain Division, TDD frame configuration, and the like.

For millimeter-wave (mmW) and/or terahertz wave (THz) the outside area interference introduces large propagation loss and very little diffraction, which causes the radio signals (antenna beams) to be blocked or lost. There is also a higher possibility of blocking of the UL and DL antenna beams due to an object.

### SUMMARY

Consequently, there is a need for an antenna system for serving a plurality of industrial devices in an industrial environment which alleviates at least some of the above-cited problems.

It is, therefore, an object of the present disclosure to provide a method, an antenna system, an apparatus, and a computer program product, to mitigate, alleviate, or eliminate all or at least some of the above-discussed drawbacks of presently known solutions.

This and other objects are achieved by means of a method, an antenna system, an industrial controller, and a computer program product as defined in the appended claims. The term exemplary is in the present context to be understood as serving as an instance, example or illustration.

According to a first aspect of the present disclosure, an antenna system for operating in an industrial environment comprising a plurality of industrial devices disclosed. The antenna system comprises an antenna and a support for supporting the antenna in an elevated position in relation to the ground and facing towards the ground. The antenna is adapted for generating beams towards the ground for communicating with the UE.

In some embodiments, the support for supporting the antenna comprises one or more of: an antenna pole for mounting the antenna; an antenna rail for sliding the antenna over the antenna rail; a drone for hangably holding the antenna; an air balloon for hangably holding the antenna; and a floating tool for hangably holding the antenna.

In some embodiments, the support for supporting the antenna comprising an antenna pole, the antenna pole being equipped with at least one motion sensor for detecting a motion of the antenna.

In some embodiments, the support for supporting the antenna comprising an antenna rail, the antenna being slidable along the antenna rail for shifting the antenna from a first location to a second location within the industrial environment; a baseband, BB processing component being located at the antenna pole, the BB processing component being in communication with the antenna using one of an optical fiber or a metallic tube present inside the antenna rail, of the support or external to the support.

In some embodiments, the support for supporting the antenna comprising the drone, the antenna being hangable from the drone with an anchored wire connected to ground or without the anchored wire; and a baseband, BB processing component being in communication with the antenna using one of the anchored wire or an optical fiber, of the support or external to the support.

In some embodiments, the support for supporting the antenna comprising the floating tool, the antenna being hangable from the floating tool with an anchored wire connected to ground or without the anchored wire and a baseband component being in communication with the antenna using one of the anchored wire or an optical fiber.

In some embodiments, the support for supporting the antenna comprising the air balloon, the antenna being hangable from the air balloon with an anchored wire connected to ground or without the anchored wire, and a baseband, BB processing component being in communication with the antenna using one of the anchored wire or an optical fiber, of the support or external to the support.

In some embodiments, the antenna system further comprises a processor to communicate with a motion sensor on the antenna pole and to: determine whether there is a motion of the antenna; and while it is determined that there is a motion of the antenna, receive, from an industrial controller, an indication for steering the antenna beams generated by the antenna.

According to a second aspect of the present disclosure, a method for providing a motion indication to an antenna, the motion indication being an indication to direct beams generated by the antenna operating in an industrial environment comprising a plurality of industrial devices, each industrial device being connected to a user equipment, UE, the method being performed by the antenna, the method comprising: receiving information related to a motion of the antenna from a plurality of motion sensors equipped in a support for supporting the antenna, identifying whether the received information indicates a movement of the antenna. When it is identified that the received information indicates a movement of the antenna, the method further comprises determining a direction for moving the beams. The method comprises providing, to the antenna, information indicating the determined direction for moving the beams towards the determined direction.

In some embodiments, the step of transmitting the information indicating the determined direction for moving the beams towards the determined direction comprises determining that the beams are to be moved in a direction opposite to a direction of the movement of the antenna and providing, to the antenna, an indication that the beams are to be moved in the opposite direction to the movement of the antenna.

According to a third aspect of the present disclosure, an apparatus for providing a motion indication to an antenna, the motion indication being an indication to direct beams generated by the antenna operating in an industrial environment comprising a plurality of industrial devices, each industrial device being connected to a user equipment, UE, the apparatus comprising a controller circuitry is disclosed. The controller circuitry is configured to reception of information related to a motion of the antenna from a plurality of motion sensors equipped in a support for supporting the antenna; identification of whether the received information indicates a movement of the antenna; when it is identified that the received information indicates a movement of the antenna, determination of a direction for moving the beams generated by the antenna; and providing of information to the antenna, the information indicating the determined direction for moving the beams towards the determined direction.

A fourth aspect is an industrial controller comprising the apparatus of the third aspect.

According to a fifth aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

An advantage of some embodiments is that alternative and/or improved approaches are provided for implementing an antenna system for serving one or more industrial devices in an industrial environment.

An advantage of some embodiments is that the antenna is installed/deployed in manner such as the antenna is hanged, or mounted using a support that supports the antenna.

An advantage of some embodiments is that the antenna is moved from one location to another location in the industrial environment to serve the industrial devices at different locations.

An advantage of some embodiments is that efficient usage of available bandwidth for communication between the antenna and the industrial devices.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates an example antenna deployment, according to prior arts;

FIG. 2 illustrates an antenna communicating in an industrial environment, according to some embodiments;

FIGS. 3a and 3b illustrate the antenna being mountably positioned on an antenna pole and communicating in the industrial environment, according to some embodiments;

FIG. 4a illustrates the antenna being slidably positioned under an antenna rail according to some embodiments;

FIG. 4b illustrates the antenna rail for sliding the antenna, according to some embodiments;

FIG. 5a illustrates the antenna being hangably positioned under an antenna rail with anchored wires, according to some embodiments;

FIG. 5b illustrates the antenna being hangably positioned under an antenna rail without anchored wires, according to some embodiments;

FIG. 6 is a flowchart illustrating example method steps according to some embodiments;

FIG. 7 is a schematic block diagram illustrating an example antenna system according to some embodiments;

FIG. 8 is a schematic block diagram illustrating an example apparatus according to some embodiments; and

FIG. 9 is a schematic block diagram illustrating an example computing environment according to some embodiments.

### DETAILED DESCRIPTION

Aspects of the present disclosure will be described more fully hereinafter with reference to the accompanying drawings. The apparatus and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

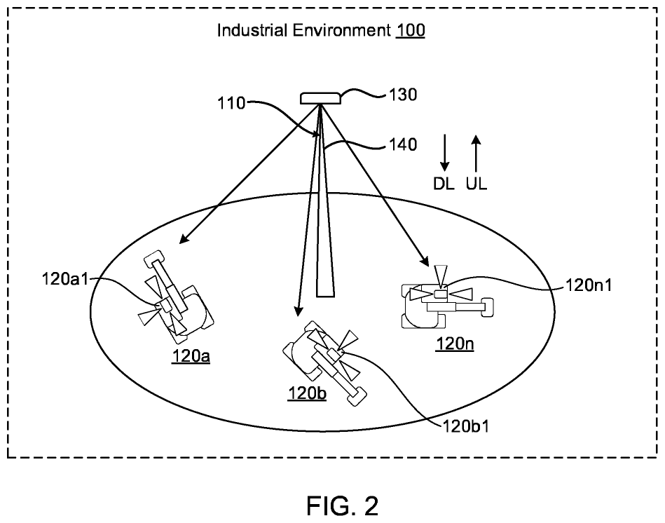

FIG. 2 discloses an example industrial environment 100. Some of the examples of the industrial environment 100 may include a factory, a manufacturing unit, guided robotic environment, a construction site, or the like. The industrial environment 100 comprises a plurality of industrial devices 120a, 120b, and so on to 120n. Each of the plurality of industrial devices 120a-120n may be equipped with a plurality of user equipments, UEs, 120a1, 120b1, and so on to 120n1. It should be noted that the industrial environment 100 is not limited to above-mentioned components, other components can also be present in the industrial environment 100 other than the components shown in the FIG. 2.

In some examples, the plurality of industrial devices 120a-120n may be a device that is stationary or mobile, and also may be referred to as a peripheral, a machinery, or the like. Examples of the plurality of industrial devices 120a-120n may include, but are not limited to, an industrial robot, a robotic arm, an automation cell, a conveyor, an excavator, a lifter, a turn-over machine, an Internet of Things device, IoT device, a 6DOF robotic arm, collaborating robotic arms, Automated Guided Vehicles, AGVs, with omni-wheels, or any other similar device.

The plurality of industrial devices 120a-120n are connected to the plurality of UEs 120a1-120n1. In some examples, the plurality of industrial devices 120a1-120n1 are connected to the plurality of plurality of UEs 120a1-120n1 using at least one of: a wired network, a cellular network, a wireless local area network, LAN, Wi-Fi, Bluetooth, Bluetooth low energy, Zigbee, Wi-Fi direct, WFD, Ultra-wideband, UWB, infrared data association, IrDA, near field communication, NFC, and so on.

The plurality of industrial devices 120a-120n may be configured to perform one or more operations in accordance with one or more control messages generated by the industrial controller (not shown). The plurality of industrial devices 120a-120n may receive the one or more control messages from an antenna system 110 through the plurality of UEs 120a1-120n1. The control messages may comprise a set of commands intended for controlling the plurality of industrial devices 120a-120n. The set of commands instruct the plurality of industrial devices 120a-120n to perform the one or more operations. The plurality of industrial devices 120a-120n executes an industrial application for performing the one or more operations. The industrial application may include, an industrial process automation based application, a building automation based application, an application intended for monitoring electrical distribution networks, or the like.

The plurality of UEs 120a1-120n1 may be a wireless device that is stationary or mobile and may also be referred to as a remote station, a mobile station, mobile equipment, a terminal, a remote terminal, an access terminal, or the like. Examples of the wireless device may include, but are not limited to, a cellular phone, a personal digital assistant, PDA, a wireless modem, a wireless communication device, a handheld device, a subscriber unit, a laptop computer, and so on.

In industrial environment 100, an antenna 130 is implemented for communicating with the one or more industrial devices. The antenna 130 transmits the control messages to each UE 120a1-120n1 using beams generated by the antenna 130. The beam is directed towards the UE 120a1-120n1 for transmitting the control messages to the UE 120a1-120n1. For example, the beam is generated by the antenna 130 for transmitting or receiving the signals to/from the UE 120a1-120n1. The beam from the antenna 130 to UE 120a1-120n1 is termed as downlink, DL antenna beam and the beam from the UE 120a1-120n1 to the antenna 130 is termed as uplink, UL antenna beam. In conventional system, the beams generated by the antenna 130 are in vertical as well as horizontal directions. The beams in the horizontal direction often interfere with beams generated from another antenna covering another geographical location. This may cause an outside area interference. The outside area interference introduces large propagation loss and very little diffraction, which causes the radio signals (beams) to be blocked or lost. There is also a higher possibility of blocking of the uplink, UL and downlink, DL antenna beams due to an object present in the industrial environment 100.

Therefore, according to some embodiments of the present disclosure, an antenna system 110 may be implemented for operating in an industrial environment 100 comprising plurality of industrial devices 120a-120n. Each industrial device 120a-120n is connected to a UE 120a1-120n1.

The antenna system 110 comprises an antenna 130 and a support for supporting the antenna 130. The support is for supporting the antenna 130 in an elevated position in relation to ground and facing towards the ground. In some examples, the support along with the antenna 130 is adapted for generating vertical beams towards the ground for communicating with the plurality of industrial devices 120a-120n using the plurality of UEs 120a1-120n1. The antenna 130 is positioned such that the beams generated by the antenna 130 are only in vertical direction forming a shower pattern. Thus, the antenna 130 may be termed as a shower antenna.

Further, the antenna 130 is positioned at a desired altitude using the support. In some examples, the support for supporting antenna may be one of an antenna pole, an antenna rail, a drone, a balloon, a levitated means, a floating tool, or the like.

The antenna 130 may be mountably positioned, or may be hangably positioned, or may be slidably positioned for generating the beams in vertical direction towards the plurality of industrial device 120a-120n. Thus, the beams generated in the vertical direction avoids the outside area interference. Various embodiments of deployment of the antenna system 110 are explained in conjunction with figures in the later parts of the description.

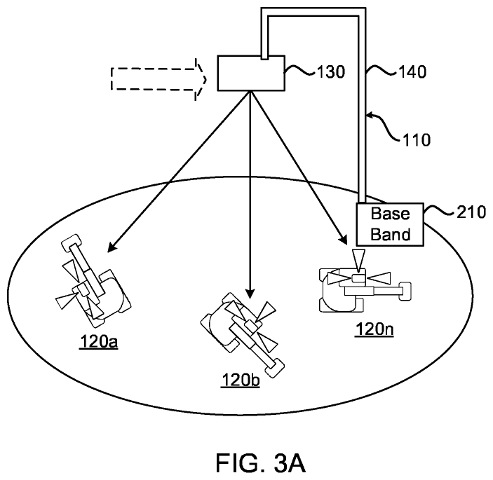

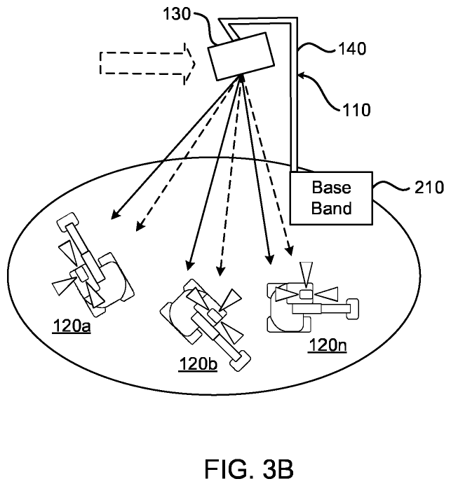

FIG. 3A illustrates the antenna 130 is mountably positioned on the support 140 and communicating in the industrial environment. As illustrated in FIG. 2, the antenna 130 is installed at the altitude on the antenna pole 140 such antenna beams are communicated only in the vertical direction, providing the shower effect.

FIG. 3A discloses an example illustration of implementation of the antenna system 110. The antenna system 110 comprises the antenna 130 and the support 140 supporting the antenna 130 in an elevated position in relation to ground and facing towards the ground. In an example, as depicted in FIG. 3A, the support 140 may be an antenna pole. Further, there exists a baseband, BB, processing component 210 located at the support 140. The BB processing component 210 is in communication with the antenna 130 through a fronthaul. The fronthaul is a communication medium between the antenna 130 and the BB processing component 210. In some examples, the fronthaul is one or more of an optical fiber, a metallic tube present inside the support 140 or the metallic tube present external to the support 140.

In some examples, the antenna 130 may be mounted on the support 140 at a higher altitude compared to conventional antennas. The antenna 130 may be adapted to generate beams towards the ground for communicating with the plurality of UEs. Thus, the beams are directed toward the plurality of industrial devices 120a-120n only in a vertical direction.

In an example, three downlink, DL, beams generated by the antenna for communicating the one or more industrial devices is illustrated in FIG. 3A. In another example, there may be multiple beams between the antenna 130 and the plurality of UEs 120a1-120n1 attached to the plurality of industrial devices 120a-120n.

In some embodiments, the support 140 comprises one or more motion sensors. The one or more motion sensors may include, a gyroscopic sensor or any other motion sensor. The one or more motion sensors may be adapted to sense a motion of the antenna 130. In some examples, the motion of the antenna 130 may be caused due to strong winds toward the antenna 130. The flow of strong winds toward the antenna 130 is illustrated as dashed lines in the FIG. 3A. The motion of the antenna 130 may be referred to as a swaying motion and the movement of the beams may be referred to as swaying beams.

FIG. 3B discloses an example illustration of implementation of the antenna system 110. As illustrated in FIG. 3B, the antenna 130 experiences movement due to the strong winds. The movement of the antenna 130 causes movement of the beams generated by the antenna 130, which causes the distortion in the control messages to the plurality of UEs 120a1-120n1. The swayed beams are depicted as dashed lines in FIG. 3B toward the plurality of UEs 120a1-120n1.

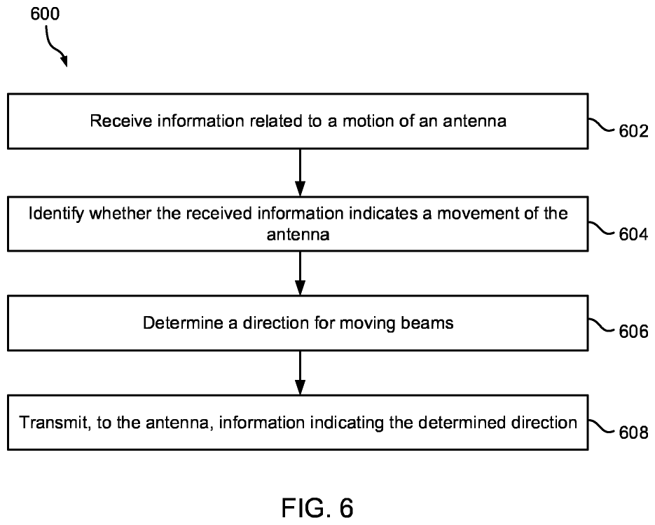

The antenna 130 transmits the information, acquired by the one or more sensors, related to the motion of the antenna 130 to the industrial controller (not shown in the figure). In response to the transmitted information, the antenna 130 may receive the information indicating a determined direction for changing the direction of the beams towards the determined direction. Determination of the direction for moving the beams by the industrial controller is described in conjunction with FIG. 6.

The antenna 130 changes the direction of the beams generated by the antenna 130 in accordance with the received information as illustrated in FIG. 3B. The direction of swayed beams is changed such as the beams are directed toward the antenna 130. For example, the direction of the swayed beams are changed toward an opposite direction to the movement of the antenna 130. The antenna beams after changing the direction are illustrated in FIG. 3B as solid lines. As depicted in FIG. 3B, the solid DL beams move in the opposite direction of the dashed DL beams, to avoid the effect of swaying.

Thus, the effect of the swaying motion of the antenna 130 is mitigated, and thus, the outside area interference is avoided by changing the direction of the beams in the determined direction.

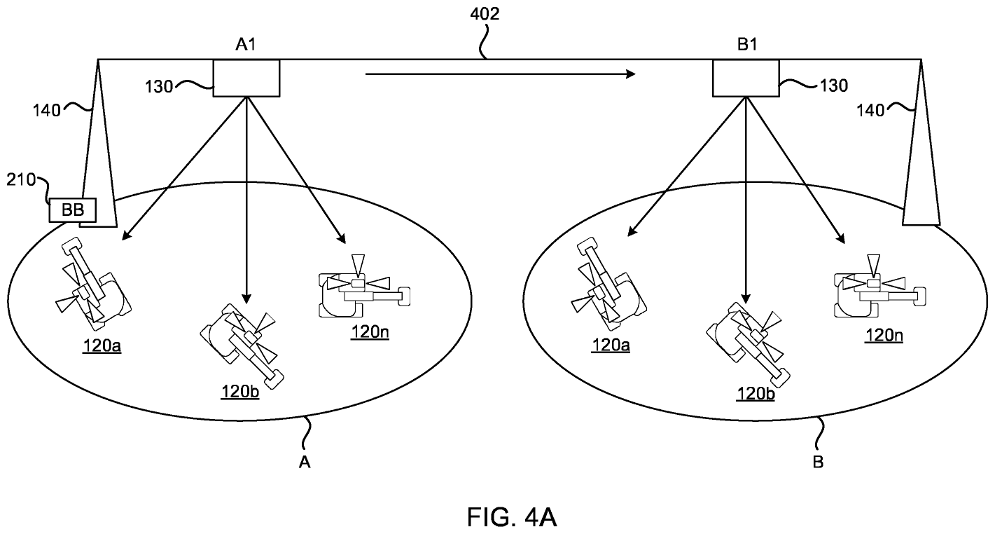

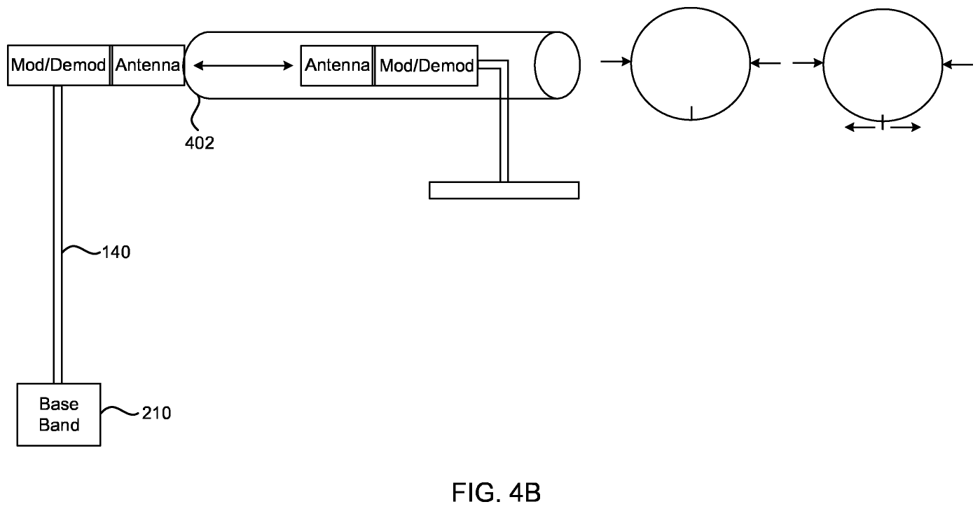

FIG. 4A discloses an example illustration of implementation of the antenna system 110. For example, the industrial environment (e.g. a construction site) comprising the plurality of industrial devices 120a-120n such as heavy machinery, being served by the antenna 130. The construction site may cover a very large geographical area, and the heavy machinery usually move from one location to another location in the construction site. The movement of the industrial devices 120a-120n makes it difficult for the antenna 130 to serve the plurality of industrial devices 120a-120n present on the construction site. Further, moving the antenna 130 along with the support in accordance with the movement of the heavy machinery is very time consuming along with cost consuming.

For such scenarios, the present embodiment discloses that the support for supporting the antenna 130 comprises an antenna rail 402. The antenna 130 is slidable along the antenna rail 402 for shifting the antenna 130 from a first location to a second location within the industrial environment.

Further, the antenna system comprises the BB processing component 210 located at the support 140. The BB processing component 210 is in communication with the antenna 130 using one of an optical fiber, a metallic tube present inside the antenna rail 402 or the metallic tube present external to the antenna rail 402.

The antenna 130 is easily slidable under the antenna rail 402 for moving the antenna 130 from one location to another without moving the support. In an example, the antenna rail 402 may be fixed in between structures such as buildings, present at the construction site. In another example, the antenna rail 402 may be supported by the support. The antenna rail 402 may be a one-dimensional rail or a two-dimensional rail depending upon the construction site.

Since, the antenna 130 is installed at a higher altitude than conventional antennas, strong winds blowing at the higher altitude may cause a swaying motion of the antenna 130. The swaying motion of the antenna 130 causes swaying of the beams. The swaying of the beams results in performance degradation of the antenna 130 with interference leakage to the outside area.

As illustrated in FIG. 4A, the antenna 130 is movable under the antenna rail 402 in accordance with the movement of the plurality of industrial devices 120a-120n. The plurality of industrial devices 120a-120n are at location A at time T1. The antenna 130 is at location A1 above the plurality of industrial devices 120a-120n and is hangings under the antenna rail 402. After some time (e.g. at time T2), the plurality of industrial devices 120a-120n are moved from location A to location B in the industrial environment, and hence to serve the plurality of industrial devices 120a-120n at location B, the antenna 130 is also moved to location B1 by sliding under the antenna rail 402. The antenna 130 is easily able move from location A1 to location B1 by using the antenna rail 402.

Further, as described in above embodiments, the support (antenna pole) comprises motion sensors (not shown in the figure). The motion sensors sense the motion of the antenna 130. Further, the motion of the antenna 130 is shared with the industrial controller. In response to the information, the antenna 130 may receive the information indicating a determined direction for changing the direction of the beams towards the determined direction as described in conjunction with FIG. 3B. Determination of the direction for moving the beams by the industrial controller is described in conjunction with FIG. 6.

FIG. 4B illustrated the antenna rail 402. As illustrated in FIG. 4B, the antenna rail 402 is supported by the support 140. The antenna 130 is in communication with the BB processing component 210 through a fronthaul between the antenna 130 and the BB processing component 210. For example, the fronthaul is provided by one or more of optical fiber, or metallic tube inside of the antenna rail 402. The BB processing component 210 generates the baseband signal and transmits the baseband signal through the fronthaul. The baseband signal is modulated to a high frequency signal by using a modulator/demodulator. The antenna rail 402 is capable of moving the antenna 130 efficiently without any leakage of the signal through the antenna rail 402. FIG. 4B further illustrates cross sectional view of the antenna rail 402.

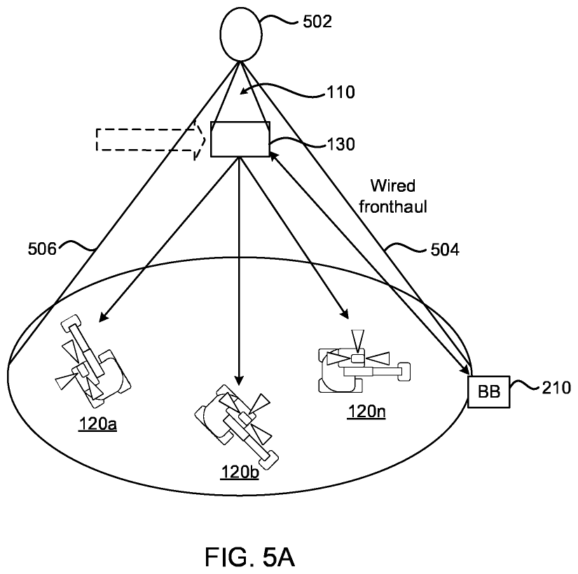

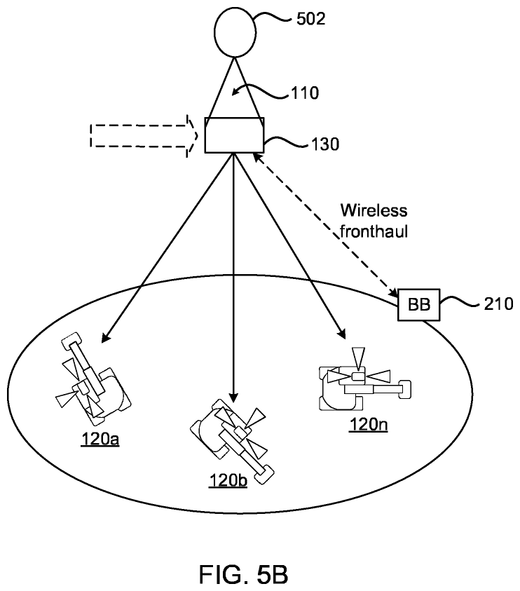

FIG. 5A discloses an example illustration of implementation of the antenna system 110. In some embodiment, the support for supporting the antenna 130 comprising the balloon 502.

In some embodiments, the balloon 502 may be replaced with any of the floating means (e.g. a drone or the like). In an example, the antenna 130 is hanged using the balloon 502 with anchored wires 504 and 506 connected to ground as illustrated in FIG. 5A. In another example, the antenna 130 is hanged using the balloon 502 without the anchored wires 504 and 506 as illustrated in FIG. 5B. Further, the antenna system 110 comprises the BB processing component 210 in communication with the antenna 130 using the anchored wires 504 and 506. For example, the anchored wires 504 and 506 is one or more of an optical fibre or a metallic tube.

Further, as illustrated in FIG. 5A, the antenna 130 being hanged from the air balloon 502 is in communication with the industrial device 120a-120n. The antenna 130 generates the beams in the vertical direction towards the industrial device 120a-120n for preventing the outside area interference.

The baseband signals are processed at the BB processing component 210 as shown in the FIG. 5A. Further, the baseband signals are transmitted to the antenna 130 through the anchored wires 504 and 506 implemented as a fronthaul.

While the antenna 130 is being hanged by the air balloon 420, the antenna 130 experiences swaying due to strong winds. The anchored wires 504 and 506 reduces swaying motion of the antenna 130 due to the strong winds. However, if the antenna 130, still experiences the swaying motion, then the swaying motion is cancelled by changing the direction of the antenna beams.

Further, as described in earlier embodiments, the support 140 comprises motion sensors (not shown in the figure). The motion sensors sense the motion of the antenna 130. Further, the motion of the antenna 130 is transmitted to the industrial controller. In response to the information, the antenna 130 may receive the information indicating a determined direction for moving the beams towards the determined direction. Determination of the direction for moving the beams by the industrial controller is described in conjunction with FIG. 6

FIG. 5B discloses an example illustration of implementation of the antenna system 110. In some embodiment, the support for supporting the antenna 130 comprising the air balloon 502. The antenna 130 is hanged from the air balloon 502 without the anchored wires. Further, the antenna system 110 comprises the BB processing component 210 in communication with the antenna 130 using the optical fiber or metallic tube.

Further, as illustrated in FIG. 5B, the antenna 130 being hanged from the air balloon 502 is in communication with the industrial devices 120a-120n in the vertical direction by the beams for preventing the outside area interference. The baseband signals are processed at the baseband component 210 as shown in the FIG. 5B. Further, the baseband signals are transmitted to the antenna 130 through wireless a fronthaul connection.

FIG. 6 illustrated a flowchart illustrating example method steps of a method 600 performed by the industrial controller for directing an antenna of an antenna system operating in a wireless communication network, for communicating with a plurality of industrial devices in an industrial environment, the plurality of industrial devices being connected to a UE.

At 602, the method 600 comprises receiving information related to a motion of the antenna. The information is received from the one or more motion sensors attached to the support.

At 604, the method 600 comprises identifying whether the received information indicates a movement of the antenna.

At 606, the method 600 comprises determining a direction for moving the antenna beams when it is identified that the received information indicates a movement of the antenna.

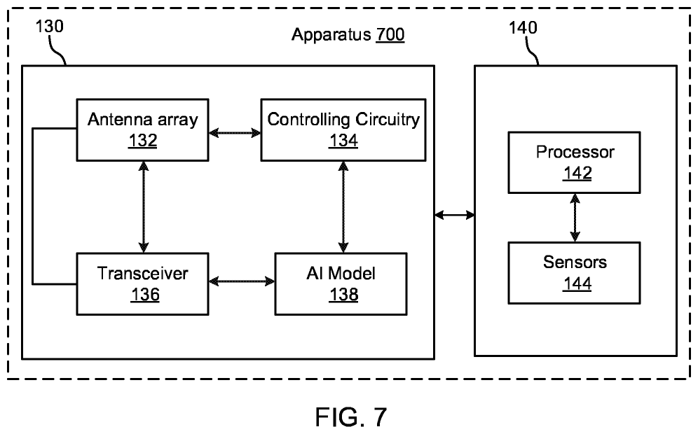

In an embodiment, the industrial controller may identify the movement of the antenna and the direction for moving the beams using an Artificial Intelligence, AI, model (as described in conjunction with FIG. 7).

At 608, the method 600 comprises transmitting, to the antenna, information indicating the determined direction for moving the beams towards the determined direction. For example, the information comprises predicting that the antenna beams are to be moved in the opposite to the direction of movement of the antenna 130.

FIG. 7 is an example schematic diagram showing the antenna 130. The antenna 130 communicates with the plurality of UEs attached to the plurality of industrial devices 120a-120n over the beams. The antenna 130 communicates with the plurality of UEs 120a1-120n1 only in the vertical direction for avoiding the outside area interference.

According to at least some embodiments of the present invention, the antenna 130 in FIG. 7 comprises one or more modules. These modules may e.g. be an antenna array 132, a controlling circuitry 134, a transceiver 136 and an AI model 138. The controlling circuitry 134, may in some embodiments be adapted to control the above mentioned modules.

The antenna array 132, the transceiver 136, the AI model as well as the controlling circuitry 134, may be operatively connected to each other.

The antenna array 132 comprises a plurality of antenna elements arranged in an array. The beams may be generated by the plurality of antenna elements.

The transceiver 136 may be adapted to direct the beams for communicating with the UEs.

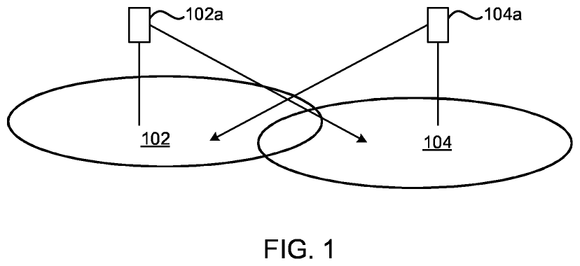

As described above, the different embodiments of enabling the antenna system, a few of which have been mentioned above in connection to the explanation of FIG. 1-5.

The controlling circuitry 134 may be adapted to control the steps as executed for generating beams towards the ground for communicating with the one or more UEs. For example, the controlling circuitry 134 may be adapted to generate the antenna beams from the antenna 130 to the UE. Thus, the controlling circuitry 134 may be adapted to communicate with the UE without the outside area interference (as described above in conjunction with FIG. 1-5). The controlling circuitry is further configured to determine the location and the time for moving the antenna 130 under the antenna rail. The controller circuitry is also configured to initiate the movement of the antenna 130 under the antenna rail from a current location to the determined location.

In addition, the transceiver 136 is also adapted to transmit information related to the motion of the antenna 130 acquired from the one or more sensors located at the support and receive information regarding the movement of the antenna beams in response to transmitted information.

The AI model 138 identifies whether the received information indicates the movement of the antenna and determines the direction for the beams (as described above in conjunction with FIG. 6).

In some examples, the AI model 138 may include, but are not limited to, a neural network model, a machine learning model, a multi-class support vector machine, SVM, model, a recurrent neural network, RNN, model, a restricted Boltzmann machine, RBM, model, a deep belief network, DBN, model, a generative adversarial network, GAN, model, a regression based neural network model, a deep reinforcement model, a deep Q-network model, and so on. The first AI model may include a plurality of nodes arranged in layers. Examples of the layers may include, but are not limited to, a convolutional layer, a concatenated layer, a dropout layer, a fully connected layer, a SoftMax layer, and so on. Each layer has weights and performs a layer operation through calculation of a previous layer and an operation of a plurality of weights/coefficients.

In some examples, the AI model 138 may be trained by applying one or more learning methods on training data for determining that the communication is being blocked by the first industrial device, or the one or more second industrial devices. In some examples, the training data include one or more of: sensor data collected from the one or more sensors positioned on the plurality of industrial devices for a period of time, information related to the one or more operations performed by the plurality of industrial devices in the industrial environment over time, information related to communications being blocked by the one or more industrial devices previously due to the associated one or more operations, and so on. In some examples, the learning methods may include one or more of: a supervised learning method, an unsupervised learning method, a semi-supervised learning method, a reinforcement learning method, and a regression-based learning based method. The trained first AI model may include a known and fixed number of layers, and sequence for processing the layers and parameters related to each layer. The parameters may include one or more of: activation functions, biases, input weights, output weights, and so on, related to the layers. A function associated with the learning method may be performed through a memory, and a controlling circuitry. The controlling circuitry may include one or more processors such as, a central processing unit, CPU, an application processor, AP, a graphics processing unit, GPU, a visual processing unit, VPU, an AI dedicated processor (like neural processing unit, NPU), and so on.

Further, the controlling circuitry 134 may be adapted to train the AI model 138.

According to at least some embodiments of the present invention, the support 140 in FIG. 7 comprises one or more modules. These modules may e.g. be a processor 142 and sensors 144. The support 140 is in communication with the antenna 130.

The sensors 144 is configured to detect the motion of the antenna 130. In an example, the sensors 144 may be a motion sensor or a direction sensor. Further, the sensors 144 transmits the detected motion to the processor 142.

The processor 142 processes the detected motion. Further, the support 140 transmits the detected motion to the antenna 130.

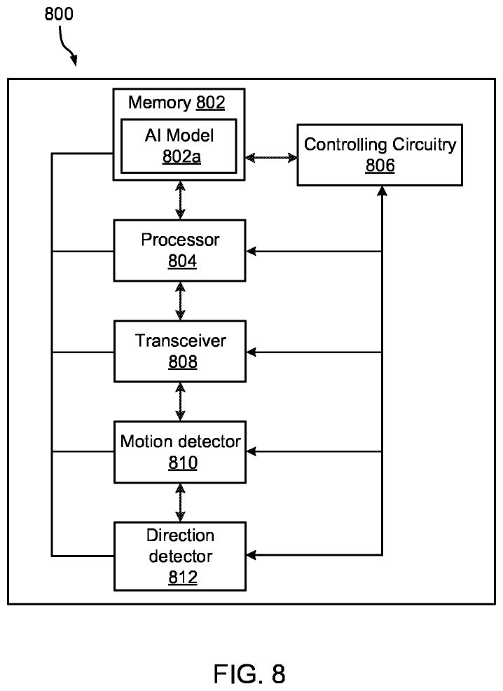

FIG. 8 is an example schematic diagram showing an apparatus 800. The apparatus 800 may e.g. be comprised in the industrial controller. The apparatus 800 is capable of instructing the antenna operating in the industrial environment comprising the plurality of industrial devices, each industrial device may be connected to the UE.

According to at least some embodiments of the present invention, the apparatus 800 in FIG. 8 comprises one or more modules. These modules may e.g. be a memory 802, a processor 804, a controlling circuitry 806, a transceiver 808, a motion detector 810, and a direction detector 812. The controlling circuitry 806, may in some embodiments be adapted to control the above mentioned modules.

The memory 802, the processor 804, the transceiver 808, the motion detector 810, the direction detector 812 as well as the controlling circuitry 806, may be operatively connected to each other.

The controlling circuitry 806 may be adapted to control the steps as executed by the industrial controller. For example, the controlling circuitry 806 may be adapted to direct the antenna for serving the one or more UEs/industrial devices (as described above in conjunction with the method 600 and FIG. 6).

The transceiver 808 may be adapted to receive information related to a motion of the antenna acquired from one or more sensors located at the antenna pole supporting the antenna.

The motion detector 810 may be adapted to identity whether the received information indicates the movement of the antenna.

The direction detector 812 may be adapted to determine the direction of the beams, when it is identified that the received information indicates the movement of the antenna.

In an embodiment, the motion detector 810 and the direction detector 812 may use an AI model 802a to identity whether the received information indicates the movement of the antenna and determine the direction for moving the beams, respectively (as described above in conjunction with FIG. 6).

Further, the processor 804 may be adapted to train the AI model 802a.

Furthermore, the memory 802 is adapted to store the AI model 802a, the information related to the movement of the antenna, and the direction determined for moving the beams.

The antenna 130 communicates with the UE attached to the plurality of industrial devices 120a-120n over the antenna beams. The antenna 130 communicates with the UE only in the vertical direction for avoiding the outside area interference.

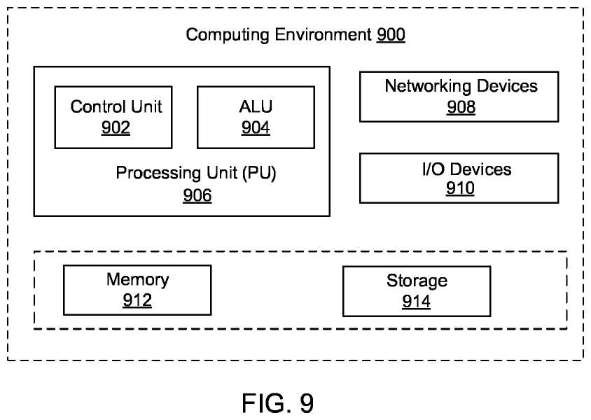

FIG. 9 illustrates an example computing environment 900. As depicted in FIG. 9, the computing environment 900 comprises at least one data processing unit hat is equipped with a control module 902 and an Arithmetic Logic Unit, ALU 904, a plurality of networking devices 908 and a plurality Input output, I/O devices 910, a memory 912, a storage 914. The data processing module 906 may be responsible for implementing the method described in FIG. 6. For example, the data processing module 906 may in some embodiments be equivalent to the controller circuitry of the antenna described above in conjunction with the FIGS. 1-8. The data processing module 906 is capable of executing software instructions stored in memory 912. The data processing unit 906 receives commands from the control unit 902 in order to perform its processing. Further, any logical and arithmetic operations involved in the execution of the instructions are computed with the help of the ALU 904.

The computer program is loadable into the data processing unit 906, which may, for example, be comprised in an electronic apparatus (such as a UE or a network node). When loaded into the data processing module 906, the computer program may be stored in the memory 912 associated with or comprised in the data processing unit 906. According to some embodiments, the computer program may, when loaded into and run by the data processing unit 906, cause execution of method steps according to, for example, the method illustrated in FIG. 6 or otherwise described herein.

The overall computing environment 900 may be composed of multiple homogeneous and/or heterogeneous cores, multiple CPUs of different kinds, special media and other accelerators. Further, the plurality of data processing units 906 may be located on a single chip or over multiple chips.

The algorithm comprising of instructions and codes required for the implementation are stored in either the memory 912 or the storage 914 or both. At the time of execution, the instructions may be fetched from the corresponding memory 912 and/or storage 914, and executed by the data processing module 906.

In case of any hardware implementations various networking devices 906 or external 1/O devices 910 may be connected to the computing environment to support the implementation through the networking devices 908 and the I/O devices 910.

The embodiments disclosed herein can be implemented through at least one software program running on at least one hardware device and performing network management functions to control the elements. The elements shown in FIG. 9 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1. An antenna system for operating in an industrial environment comprising a plurality of industrial devices, each industrial device being connected to a user equipment, the antenna system comprising:
an antenna; and
a support for supporting the antenna in an elevated position in relation to ground and facing towards the ground,
wherein the antenna being adapted for generating beams towards the ground for communicating with the UE.

2. The antenna system according to claim 1, wherein the support for supporting the antenna comprises one or more of:
an antenna pole for mounting the antenna;
an antenna rail for sliding the antenna along the antenna rail;
an air balloon for hangably holding the antenna;
a drone for hangably holding the antenna; and
a floating tool for hangably holding the antenna.

3. The antenna system according to claim 1, wherein the support for supporting the antenna comprising an antenna pole, the antenna pole being equipped with at least one motion sensor for detecting a motion of the antenna.

4. The antenna system according to claim 1, wherein:
the support for supporting the antenna comprising an antenna rail, the antenna being slidable along the antenna rail for shifting the antenna from a first location to a second location within the industrial environment; and
a baseband processing component being located at the antenna pole, the BB processing component is in communication with the antenna using one of an optical fiber or a metallic tube present inside the antenna rail, of the support or external to the support.

5. The antenna system according to claim 1, wherein:
the support for supporting the antenna comprising the drone, the antenna being hangable from the drone with anchored wires connected to ground or without the anchored wire; and
a baseband processing component being in communication with the antenna using one of the anchored wires or an optical fiber, of the support or external to the support.

6. The antenna system according to claim 1, wherein:
the support for supporting the antenna comprising the air balloon, the antenna being hangable from the air balloon with connected to ground or without the anchored wire; and
a baseband component being in communication with the antenna using one of the anchored wires or an optical fiber, of the support or external to the support.

7. The antenna system according to claim 1, wherein:
the support for supporting the antenna comprising the floating tool, the antenna being hangable from the floating tool with anchored wire connected to ground or without the anchored wire; and
a baseband component being in communication with the antenna using one of the anchored wires or an optical fiber.

8. The antenna system according to claim 1, wherein the antenna system further comprises a processor arranged to communicate with at least one motion sensor equipped with the antenna pole and to:
determine whether there is a motion of the antenna; and
while it is determined that there is a motion of the antenna, receive an indication for moving the beams generated by the antenna.

9. A method for providing a motion indication to an antenna, the motion indication being an indication to direct beams generated by the antenna operating in an industrial environment comprising a plurality of industrial devices, each industrial device being connected to a user equipment, the method being performed by the antenna, the method comprising:
receiving information related to a motion of the antenna from a plurality of motion sensors equipped in a support for supporting the antenna;
identifying whether the received information indicates a movement of the antenna;
when it is identified that the received information indicates a movement of the antenna, determining a direction for moving the beams generated by the antenna; and
providing, to the antenna, information indicating the determined direction for moving the beams towards the determined direction.

10. The method according to claim 9, wherein the step of transmitting the information indicating the determined direction for moving the beams towards the determined direction comprises:
determining that the beams are to be moved in a direction opposite to a direction of the movement of the antenna; and
providing, to the antenna, an indication that the beams are to be moved in the opposite direction to the movement of the antenna.

11. An apparatus for providing a motion indication to an antenna, the motion indication being an indication to direct beams generated by the antenna operating in an industrial environment comprising a plurality of industrial devices, each industrial device being connected to a user equipment, the apparatus comprising a controller circuitry configured to cause:
reception of information related to a motion of the antenna from a plurality of motion sensors equipped in a support for supporting the antenna;
identification of whether the received information indicates a movement of the antenna;
when it is identified that the received information indicates a movement of the antenna, determination of a direction for moving the beams generated by the antenna; and
providing of information to the antenna, the information indicating the determined direction for moving the beams towards the determined direction.

12. The apparatus of claim 11, wherein the controller circuitry is configured to cause the step of transmitting the information indicating the determined direction for moving the beams towards the determined direction by causing:
determination that the beams are to be moved in a direction opposite to a direction of the movement of the antenna; and
providing an indication to the antenna the indication indicates that the beams are to be moved in the opposite direction to the movement of the antenna.

13. An industrial controller comprising the apparatus according to claim 11.

14. A computer program product comprising a non-transitory computer readable medium, having thereon a computer program comprising program instructions, the computer program is loadable into a data processing unit and configured to cause execution of the method according to claim 9 when the computer program is run by the data processing unit.
